(19) United States
(12) Patent Application Publication
(10) Pub. No.: US 2008/0297444 A1
(43) Pub. Date: Dec. 4, 2008

(54) Plasma Display Apparatus and Driving Method Thereof

(76) Inventor: Seonghak Moon, Seoul (KR)

Correspondence Address: KED & ASSOCIATES, LLP, P.O. Box 221200, Chantilly, VA, 20153-1200, US

(21) Appl. No.: 12/094,884

(22) PCT Filed: Dec. 29, 2006
(86) PCT No.: PCT/KR2006/005893

§ 371 Date: May 23, 2008

(30) Foreign Application Priority Data
Dec. 30, 2005 (KR) 10-2005-0136102

(51) Int. Cl. G09G 3/28

(52) U.S. Cl. 345/60

(57) ABSTRACT

A plasma display apparatus and a driving method thereof performs a selective writing operation in a first subfield, and performs an selective erase operation in a second subfield to an n-th subfield.

### TECHNICAL FIELD

This document is related to a plasma display apparatus and a driving method thereof.

### BACKGROUND ART

A plasma display apparatus includes a plasma display panel and a driver supplying a driving pulse to an electrode of the plasma display panel.

The plasma display panel includes a barrier rib, and the barrier rib forms a discharge cell. An inert gas is filled in the discharge cell. The inert gas includes a main discharge gas and Xe. The main discharge gas is Ne, He or a mixed gas of Ne and He.

When a high frequency voltage is supplied to the electrode, a discharge is generated. The inert gas generates vacuum ultraviolet rays due to the discharge. The plasma display apparatus represents a next generation display apparatus because the plasma display apparatus is thin and light.

The plasma display apparatus displays an image through a reset discharge, an address discharge and a sustain discharge. The reset discharge, the address discharge and the sustain discharge are generated by a driving voltage which is supplied to the electrode.

As a resolution of the plasma display apparatus increases, an address period for selecting a discharge cell which will emit light increases, and a sustain margin decreases according to an increase of the address period.

### DISCLOSURE OF INVENTION

### Technical Problem

Embodiments provide a plasma display apparatus and a driving method thereof for decreasing an address period and increasing a margin of a sustain period.

### Technical Solution

A plasma display apparatus according to an embodiment of an present invention comprises a plasma display panel including a scan electrode and an address electrode, and displaying an image during a frame comprising a first subfield to an n-th subfield, a scan driver supplying a first scan pulse to the scan electrode during the first subfield, and supplying a second scan pulse having a width less than a width of the first scan pulse during a second subfield to the n-th subfield and a data driver supplying a data pulse synchronized with the first scan pulse for selecting a first discharge cells emitting light to the address electrode, and supplying a data pulse synchronised with the second scan pulse for selecting a second discharge cells, which are not emitting light, of the first discharge cells to the address electrode during the second subfield to the n-th subfield.

### ADVANTAGEOUS EFFECTS

Embodiments improve a contrast characteristic, decrease an address period, and increase a margin of a sustain period.

### BRIEF DESCRIPTION OF THE DRAWINGS

FIG. 1 illustrates a plasma display apparatus according to an embodiment of a present invention;

FIG. 2 illustrates a driving method of the plasma display apparatus according to an embodiment of a present invention; and

FIG. 3 illustrates a priming pulse and a second scan pulse supplied when the plasma display apparatus according to the embodiment of the present invention performs a selective erasing operation.

### BEST MODE FOR CARRYING OUT THE INVENTION

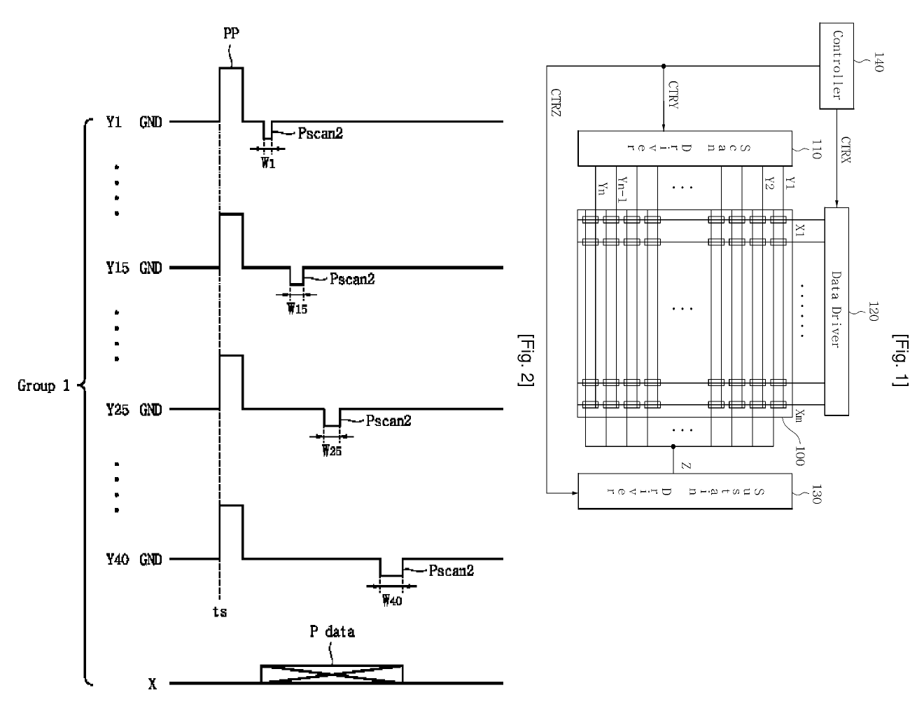

As shown in FIG. 1, an embodiment of a present invention of a plasma display apparatus includes a plasma display panel 100, a scan driver 110, a data driver 120, a sustain driver 130, and a controller 140.

The plasma display panel 100 includes an upper substrate (not shown) and a bottom substrate (not shown). The upper substrate is coalescent with the bottom substrate with a given distance. A plurality of scan electrodes Y1 to Yn and a plurality of sustain electrodes Z1 to Zn are positioned on the upper substrate. A plurality of address electrodes X1 to Xm are positioned on the bottom substrate. The plurality of address electrodes X1 to Xm cross the plurality of scan electrodes Y1 to Yn and the plurality of sustain electrodes Z1 to Zn. The plasma display panel 100 displays an image during a frame comprising a first subfield to an n-th subfield.

The scan driver 110 supplies a reset pulse to the plurality of scan electrodes Y1 to Yn. The reset pulse initializes a state of wall charges within all discharge cells formed during a previous subfield during a reset period of a next subfield under a control of the controller 140. The scan driver 110 supplies a scan pulse to the plurality of scan electrodes Y1 to Yn sequently during an address period under control of the controller 140. The scan driver 110 supplies a first scan pulse to the plurality of scan electrodes Y1 to Yn during a first subfield, and supplies a second scan pulse having a width less than a width of the first scan pulse to the plurality of scan electrodes Y1 to Yn during a second subfield to the n-th subfield.

The data driver 120 supplies a data pulse synchronized with the first scan pulse for selecting a first discharge cells emitting light to the plurality of address electrodes X1 to Xm, and supplies a data pulse synchronised with the second scan pulse for selecting a second discharge cells, which are not emitting light, of the first discharge cells during the second subfield to the n-th subfield to the plurality of address electrodes X1 to Xm.

The plasma display apparatus according to the embodiment of the present invention displays an image in the first subfield through a selective writing operation, and displays an image in the second subfield to the n-th subfield through a selective erasing operation.

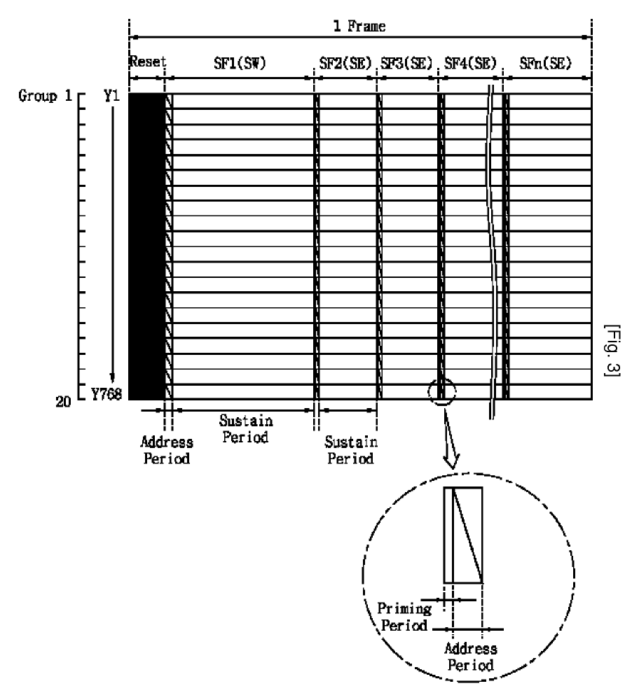

The scan driver 110 and the data driver 120 will be described with reference to FIG. 2 and FIG. 3.

The sustain driver 130 supplies a bias voltage to a sustain electrode Z during a set-down period to the address period. The sustain driver 130 supplies a sustain pulse to the sustain electrode during a sustain period. The level of the bias voltage may be substantially equal to the level of a sustain pulse.

The controller 140 receives a vertical synchronizing signal and a horizontal synchronizing signal, generates timing control signals CRTX, CRTY, CTRZ for controlling a synchronization and an operation timing of each of drivers 110, 120, 130 during the reset period, the address period and the sustain period, and controls each of drivers 110, 120, 130 through supplying the timing control signals CRTX, CRTY, CTRZ to the drivers 110, 120, 130.

As shown in FIG. 2, the plasma display apparatus according to the embodiment of the present invention displays an image by a frame comprising a first subfield SF1 to an n-th subfield SFn. n may range from 8 to 40. The plasma display apparatus according to the embodiment of the present invention performs a selective erasing operation. The plasma display apparatus according to the embodiment of the present invention can decrease an address period of each subfield, and increase the number of subfields of one frame. The plasma display apparatus according to the embodiment of the present invention can improve an ability of a gray level representation due to the increase of the number of subfields.

Because the plasma display apparatus according to the embodiment of the present invention performs a selective writing operation during the first subfield SF1, the first subfield SF1 includes a reset period for uniforming wall charges formed in all discharge cells, an address period for selecting the first discharge cells emitting light, and a sustain period in which the first discharge cell emits light. Since the plasma display apparatus according to the embodiment of the present invention performs an selective erasing operation during the second subfield SF1 to the n-th subfield SFn, each of the second subfield SF1 to the n-th subfield SFn comprises an address period in which the second discharges, which are not emitting light, of the first discharge cells.

The plasma display apparatus according to the embodiment of the present invention which performs the selective writing operation, makes all discharge cells not emit light in the reset period, and increase the ration of the brightness in the sustain period to a brightness in the reset period. The plasma display apparatus according to the embodiment of the present invention improves a contrast characteristic through the increase of the ratio.

The plasma display apparatus according to the embodiment of the present invention which performs the selective writing operation, selects discharge cells which will not emit light through erasing some wall charges formed in discharge cells which emitted light in the first subfield SF1. Because a width of a scan pulse supplied in address periods of the second subfield SF2 to the n-th subfield SFn in which the selective erasing operation is performed, is less than a width of a scan pulse supplied in an address period of the first subfield SF1 in which the selective writing operation is performed, some wall charges formed in discharge cells which emitted light are erased.

Since the width of a scan pulse supplied in address periods of the second subfield SF2 to the n-th subfield SFn, is less than the width of a scan pulse supplied in an address period of the first subfield SF1, a duration of each of the address periods of the second subfield SF2 to the n-th subfield, is less than the address periods of the first subfield SF1.

The plasma display apparatus according to the embodiment of the present invention can decrease the address period, increase a margin of the sustain period, and improve a contrast characteristic.

The plasma display apparatus according to the embodiment of the present invention may display an image by supplying a scan pulse to a scan electrode group. As shown in FIG. 2, when the total number of scan electrodes is 768 and all the scan electrodes are divided into 20 scan electrode groups Group 1 to Group 20, the plasma display apparatus according to the embodiment of the present invention may scan pulses to the scan electrode groups Group 1 to Group 20 without respect to the sequence of the scan electrode groups Group 1 to Group 20.

For example, when the first scan electrode group Group 1, the second scan electrode group Group 2 and the third electrode group Group 3 are adjacent each other, the plasma display apparatus according to the embodiment of the present invention may supply scan pulses in the order of the first scan electrode group Group 1, the second scan electrode group Group 2 and the third electrode group Group 3, in the order of the second scan electrode group Group 2, the first scan electrode group Group 1 and the third electrode group Group 3, or in the order of the third electrode group Group 3, the second scan electrode group Group 2, and the first scan electrode group Group 1.

The plasma display apparatus according to the embodiment of the present invention may supply scan pulses to scan electrodes of a scan electrode group sequently. For example, when one scan electrode group includes a scan electrode Y1 to a scan electrode Y10, The plasma display apparatus according to the embodiment of the present invention may sequently supply the first scan pulses or the second scan pulses to the scan electrode Y1 to the scan electrode Y10.

The scan driver 110 of the plasma display apparatus according to the embodiment of the present invention may supply a priming pulse which has a second polarity different from a first polarity of the second scan pulse before supplying the second scan pulse. At least one of the second subfield SF2 to the n-th subfield may include a priming period before an address period.

As shown in FIG. 3, when one scan electrode group includes 40 scan electrodes Y1 to Y40, the scan driver 110 of FIG. 1 supplies the priming pulses PP to the scan electrodes Y1 to Y40, and supplies the second scan pulses Pscan2 to the scan electrodes Y1 to Y40. The first polarity of the second scan pulse Pscan2 is different from the second polarity of the priming pulse PP. For example, when the first polarity is a positive polarity, the second polarity is a negative polarity. The positive polarity means that a level of the highest voltage of a pulse is higher than a level of a ground voltage GND, and the negative polarity means that a level of the lowest voltage of a pulse is lower than the level of the ground voltage GND.

The scan driver 110 may supply the priming pulses PP to the scan electrodes Y1 to Y40 at the same time point ts.

The priming pulses PP compensate wall charges erased naturally before the supply of the second scan pulse Pscan2 during the address period. Namely, the priming pulses PP prevent mis-discharge due to an erase of the wall charges, improves a priming effect, and makes discharge generated exactly. The plasma display apparatus according to the embodiment of the present invention can be driven at a high speed due to the priming pulses PP.

When the plasma display panel 100 comprises a first scan electrode and a second electrode and the scan driver 110 supplies the second scan pulse to the second electrode after a supply of the second scan pulse to the first scan electrode, a width of the second scan pulse supplied to the second scan electrode may be greater than a width of the second scan pulse supplied to the first scan electrode. For example, as shown in FIG. 3, when the scan driver 110 supplies the second scan pulse Pscan2 to the scan electrode Y15 after a supply of the second scan pulse Pscan2 to the scan electrode Y1, a width W15 of the second scan pulse Pscan2 supplied to the scan electrode Y15 may be greater than a width W1 of the second scan pulse Pscan2 supplied to the scan electrode Y1.

Namely, a declination of wall charges generated by an erase of wall charges according to a past of time, is decreased.

1. A plasma display apparatus comprising:
a plasma display panel including a scan electrode and an address electrode, and displaying an image during a frame comprising a first subfield to an n-th subfield;
a scan driver supplying a first scan pulse to the scan electrode during the first subfield, and supplying a second scan pulse having a width less than a width of the first scan pulse during a second subfield to the n-th subfield; and
a data driver supplying a data pulse synchronized with the first scan pulse for selecting a first discharge cells emitting light to the address electrode, and
supplying a data pulse synchronised with the second scan pulse for selecting a second discharge cells, which are not emitting light, of the first discharge cells to the address electrode during the second subfield to the n-th subfield.

2. The plasma display apparatus of claim 1, wherein the scan driver supplies a priming pulse having a second polarity different from the first polarity of the second scan pulse to the scan electrode before a supply of the second scan pulse.

3. The plasma display apparatus of claim 1, wherein the plasma display panel includes a first scan electrode and a second scan electrode, and
the scan driver supplies the priming pulses to the first scan electrode and the second scan electrode at the same time point.

4. The plasma display apparatus of claim 1, wherein n ranges from 8 to 40.

5. The plasma display apparatus of claim 1, wherein the plasma display panel includes a first scan electrode and a second scan electrode,
the scan driver supplies the second scan pulse to the second scan electrode after a supply of the second scan pulse to the first scan electrode, and
a width of the second scan pulse supplied to the second scan electrode is greater than a width of the second scan pulse supplied to the first scan electrode.

6. The plasma display apparatus of claim 1, wherein the plasma display panel includes a first scan electrode group comprising a first scan electrode, and a second scan electrode group comprising a second scan electrode, and the first scan electrode group is adjacent to the second scan electrode group, and wherein the scan driver supplies the first scan pulse or the second scan pulse to the second scan electrode group before a supply of the first scan pulse or the second scan pulse to the first scan electrode group.

7. A driving method of a plasma display apparatus including a scan electrode and an address electrode, and displaying an image during a frame comprising a first subfield to an n-th subfield, comprising:
supplying a first scan pulse to the scan electrode during the first subfield;
supplying a data pulse synchronized with the first scan pulse for selecting a first discharge cells emitting light to the plurality of address electrodes;
supplying a second scan pulse having a width less than a width of the first scan pulse during a second subfield to the n-th subfield; and
supplying a data pulse synchronised with the second scan pulse for selecting a second discharge cells, which are not emitting light, of the first discharge cells to the address electrode during the second subfield to the n-th subfield.

8. The driving method of claim 7, wherein a priming pulse having a second polarity different from the first polarity of the second scan pulse, is supplied to the scan electrode before a supply of the second scan pulse.

9. The driving method of claim 7, wherein the plasma display panel includes a first scan electrode and a second scan electrode, and the priming pulses are supplied to the first scan electrode and the second scan electrode at the same time point.

10. The driving method of claim 7, wherein n ranges from 8 to 40.

11. The driving method of claim 7, wherein the plasma display panel includes a first scan electrode and a second scan electrode,
the second scan pulse is supplied to the second scan electrode after a supply of the second scan pulse to the first scan electrode, and
a width of the second scan pulse supplied to the second scan electrode is greater than a width of the second scan pulse supplied to the first scan electrode.

12. The driving method of claim 1, wherein the plasma display panel includes a first scan electrode group comprising a first scan electrode, and a second scan electrode group comprising a second scan electrode, and the first scan electrode group is adjacent to the second scan electrode group,
wherein the first scan pulse or the second scan pulse is supplied to the second scan electrode group before a supply of the first scan pulse or the second scan pulse to the first scan electrode group.
